(19) United States
(12) Patent Application Publication
(10) Pub. No.: US 2016/0112221 A1
(43) Pub. Date: Apr. 21, 2016

(54) METHOD FOR UE AND USER EQUIPMENT

(71) Applicant: SHANGHAI LANGBO COMMUNICATION TECHNOLOGY COMPANY LIMITED, Shanghai (CN)

(72) Inventor: XiaoBo Zhang, Shanghai (CN)

(21) Appl. No.: 14/892,937

(22) PCT Filed: Nov. 23, 2014
(86) PCT No.: PCT/CN2014/092312

§ 371 Date: Nov. 20, 2015

(30) Foreign Application Priority Data
Nov. 27, 2013 (CN) 201310636405.X

(51) Int. Cl. H04L 25/03; H04W 76/02

(52) U.S. Cl. CPC H04L 25/03866; H04W 76/023

(57) ABSTRACT

The disclosure is related to a method used in a user equipment and a user equipment thereof. The UE determines an initialization value of of a scrambling sequence generator in step 1, wherein the initialization value is determined by one or more of a first ID, a second ID and a time slot index; generates a D2D scrambling sequence in step 2; and performs a scrambling operation on a D2D signal by using the D2D scrambling sequence and transmits the D2D signal performed by the scrambling operation. In one embodiment, the second ID is one element in an integer set from 504 to 3080. In the disclosure, the UE performing D2D communication is capable to reuse a formula generating the initialization value of the current PUSCH scrambling sequence generator and the base station is capable to distinguish the D2D signal and the uplink data at the same, so as to avoid occurrence of the severe interference due to the same cell physical ID. The disclosure is capable to support the UE performing D2D communication inside or outside the cell coverage at the same time.

### CROSS-REFERENCE TO RELATED APPLICATION

This application is a U.S. National Phase application under 35 U.S.C. §371 of International Application No. PCT/CN2014/092312, filed on Nov. 26, 2014, and claims benefit to Chinese Patent Application No. CN 201310636405.X, filed on Nov. 27, 2013, all of which is hereby incorporated by reference for all purposes. The International Application was published in China on Jun. 4, 2015 as WO2015078379 A1 under PCT Article 21 (2).

### BACKGROUND

1. Technical Field

The disclosure is related to a scrambling scheme in the Device to Device (D2D) communication, and more particular to a scrambling scheme in the D2D of the Long Term Evolution (LTE).

2. Related Art

In the traditional LTE system of 3rd Generation Partnership Project (3GPP), a data or a channel quality indicator (CQI) on the physical uplink share channed (PUSCH) is applied by a scrambling operation:

b̅(i)=(b(i)+c(i))mod2

Wherein, b̅(i), b(i) and c(i) are the i-th bit of the data after scrambled, the i-th bit of the data before scrambled and the i-th bit of the scrambling code sequence, respectively. c(i) is determined by a pseudo-random gold sequence, referring to section 7.2 in the technical specification (TS) 36.211 for specific details, wherein an initialization value of the second m sequence generator is:

cᵢₙᵢₜ=n_{RNTI}·2¹⁴+q·2¹³+└nₛ/2┘·2⁹+N_{ID}^{cell}

Wherein, n_{RNTI}, nₛ, and N_{ID}^{cell} are a radio network temporary identifier (RNTI), an index of the time slot of PUSCH in a radio frame and a physical identifier (ID) of a service cell of a user equipment, respectively; q is 0 or −1 for identifying a maximum of 2 code words.

In the traditional 3GPP version, the data transmission occurs between the base station and the user equipment (UE). In 3GPP R (Release) 12, D2D communication is approved and discussed. The essential characteristic of D2D is to allow data transfer between the UEs. For FDD and TDD system, 3GPP has concluded that the UE is not allowed for simultaneous receiving and transmitting in D2D system in the Radio Access Network Working Group 1 (RAN1) #73 meeting. Furthermore, for avoiding the interference of the downlink data on D2D communication, the UE occupies the uplink resource, i.e. the uplink frequency band of FDD and the uplink subframe of the subframe (TDD) for D2D communication (the downlink subframe of TDD needs further discussion). In RAN1 #74bis meeting, it is concluded that the subframe used in D2D communication employs the multi-address manner of SC-FDMA. Further, the physical channel for D2D communication reuses the structure of LTE PUSCH as far as possible, which includes the channel code, the demodulation reference signal, the cyclic redundancy check code, the scrambling, etc.

As the above description, the initialization value of the traditional PUSCH scrambling sequence generator is determined by the RNTI of UE, the physical ID of the service cell of the UE and the time slot index. For the UEs performing D2D communication, the assignment of the RNTI and the physical ID of the service cell require further optimization. The main reason includes:
how to determine the RNTI and the physical ID of the service cell for the UEs performing D2D communication located outside the network coverage;
how to determine the RNTI for the UEs performing D2D communication, which are located inside the network coverage and under the radio resource control idle (RRC-Idle) state; and
how can the base station recognize whether the received signal is a D2D signal or the uplink signal of an adjacent service cell.

For the above problems, the disclosure provides a scrambling scheme in the

D2D communication.

### SUMMARY

The disclosure provides a method used in a user equipment (UE), wherein the method includes the following steps:

A. determining an initialization value of a scrambling sequence generator, wherein the initialization value is determined by at least one of the following:
a first ID;
a second ID; and
a time slot index;

B. generating a D2D scrambling sequence;

C. performing a scrambling operation on a D2D signal by using the D2D scrambling sequence;
wherein, the first ID is one element in an integer set from 0 to 65535, the second ID is one element in an integer set from 504 to 3080, and the time slot index is one element in an integer set from 0 to 19. The initialization value has a linear relationship with at least one of the following:
the first ID;
the second ID; and
the time slot index.

The above integer set from 0 to 65535 is an obtained values set of RNTI (e.g, the hexadecimal values from 0000 to FFFF). An obtained value range of the second ID reuses the formula generating the initialization value of the current PUSCH scrambling sequence generator and is obtained by calculating the second ID substituting the cell physical ID, and the integer set 504 to 3080 is a retention value which has not been assigned. The above integer set from 0 to 19 is an obtained values set of nₛ.

The above method achieves the interference randomization of D2D signal and LTE uplink data, which avoids the occurrence of the severe interference due to the same cell physical ID.

Specifically, according to one aspect of the disclosure, the UE is located outside a network coverage, and the second ID is a constant value X. In one embodiment, the X is −1.

Specifically, according to one aspect of the disclosure, the UE is located outside a network coverage, and the first ID is determined by the international mobile equipment identity (IEMI) of the UE.

IEMI is the global unique identity of the UE. Obtaining the first ID by using IEMI may effectively randomize the interference among the users. In one embodiment, the first ID equals to mod(IMEI, 2¹⁶).

Specifically, according to one aspect of the disclosure, the UE is located inside a network coverage, and the second ID equals a physical ID of a service cell of the UE plus an offset value Y, and Y is an integer.

According the above aspect of the disclosure, the base station may distinguish whether the received signal is a D2D signal or an interference signal of an adjacent cell. It is advantageous to the interference co-operation between the base stations. In one embodiment, Y is 504

Specifically, according to one aspect of the disclosure, a slope of the first ID to the initialization value is 16384, and a slope of the second ID to the initialization value is 1.

In one embodiment, calculation of the initialization value reuses the formula generating the initialization value of the current PUSCH scrambling sequence generator, wherein the first ID and the second ID replace n_{RNTI} and N_{ID}^{cell} respectively, i.e. cᵢₙᵢₜ=first ID·2¹⁴+q·2¹³+[nₛ/2]·2⁹+2⁹+second ID.

Specifically, according to one aspect of the disclosure, the step A further comprises the following steps:

A0. transmitting a wireless signal for indicating at least one of the following:
the first ID;
the second ID; and
the time slot index.

In one embodiment, the wireless signal comprises at least one of following:
Zadoff-Chu sequence;
pseudo-random sequence; and
an information block.

The disclosure provides a method used in a user equipment (UE), wherein the method includes the following steps:

A. determining an initialization value of a scrambling sequence generator, wherein the initialization value is determined by at least one of the following:
a first ID;
a second ID; and
a time slot index;

B. generating a D2D scrambling sequence;

C. performing a descrambling operation on a demodulated D2D signal by using the D2D scrambling sequence.

Wherein, the first ID is one element in an integer set from 0 to 65535, the second ID is one element in an integer set from 504 to 3080, and the time slot index is one element in an integer set from 0 to 19. The initialization value has a linear relationship with at least one of the following:
the first ID;
the second ID; and
the time slot index.

Specifically, according to one aspect of the disclosure, the UE is located outside a network coverage, and the second ID is a constant value X.

Specifically, according to one aspect of the disclosure, the UE is located outside a network coverage, and the first ID is determined by the IEMI of the UE.

Specifically, according to one aspect of the disclosure, the UE is located inside a network coverage, and the second ID equals a physical ID of a service cell of the UE plus an offset value Y, and Y is an integer.

Specifically, according to one aspect of the disclosure, the step A further comprises the following steps:

A0. receiving a wireless signal for indicating at least one of the following:
the first ID;
the second ID; and
the time slot index.

The disclosure provides a user equipment, wherein the user equipment comprises:
a first module for determining an initialization value of a scrambling sequence generator;
a second module for generating a D2D scrambling sequence; and
a third module for performing a scrambling operation on a D2D signal by using the D2D scrambling sequence.

Wherein, the first ID is one element in an integer set from 0 to 65535, the second ID is one element in an integer set from 504 to 3080, and the time slot index is one element in an integer set from 0 to 19. The initialization value is determined by at least one of the following:
a first ID;
a second ID; and
a time slot index.

The initialization value has a linear relationship with at least one of the following:
the first ID;
the second ID; and
the time slot index.

In one embodiment, the first module further transmits a wireless signal for indicating at least one of the following:
the first ID;
the second ID; and
the time slot index.

The disclosure provides a user equipment, which the user equipment comprises:
a first module for determining an initialization value of a scrambling sequence generator;
a second module for generating a D2D scrambling sequence; and
a third module for receiving the scrambled D2D signal and performing a descrambling operation on a demodulated D2D signal by using the D2D scrambling sequence.

Wherein, the first ID is one element in an integer set from 0 to 65535, the second ID is one element in an integer set from 504 to 3080, and the time slot index is one element in an integer set from 0 to 19. The initialization value is determined by at least one of the following:
a first ID;
a second ID; and
a time slot index.

The initialization value has a linear relationship with at least one of the following:
the first ID;
the second ID; and
the time slot index.

In one embodiment, the first module further receives a wireless signal for indicating at least one of the following:
the first ID;
the second ID; and
the time slot index.

The disclosure solves the problem of the initialization of the scrambling sequence generator in D2D system. Through reasonably assigning the first ID and the second ID to the UE performing D2D communication, such that the UE performing D2D communication is capable to reuse the formula for generating he initialization value of the current PUSCH scrambling sequence generator and the base station is capable to distinguish the D2D signal and the uplink data at the same. Further, the IMEI is associated with the first ID to randomize the interference between the D2D signals. The disclosure is capable to support the UE performing D2D communication inside or outside the cell coverage at the same.

### BRIEF DESCRIPTION OF THE DRAWINGS

The above and other exemplary aspects, features and advantages of certain exemplary embodiments of the present disclosure will be more apparent from the following description taken in conjunction with the accompanying drawings, in which:

FIG. 1 is a flowchart of determining D2D communication according to one embodiment of the present disclosure;

FIG. 2 is a schematic block diagram illustrating the scrambling processing apparatus according to one embodiment of the present disclosure; and

FIG. 3 is a schematic diagram illustrating the descrambling processing apparatus according to one embodiment of the present disclosure.

### DETAILED DESCRIPTION

The following description with reference to the accompanying drawings is provided to explain the exemplary embodiments of the disclosure. Note that in the case of no conflict, the embodiments of the present disclosure and the features of the embodiments may be arbitrarily combined with each other.

### Embodiment I

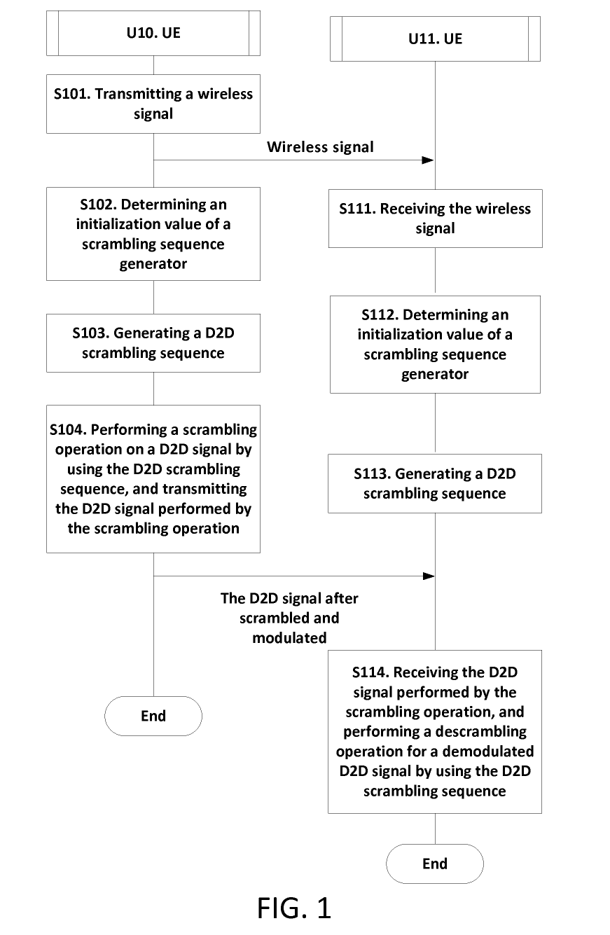

Embodiment I illustrates the flowchart of the D2D communication, as shown in FIG. 1. In FIG. 1, the UE U10 and the UE U11 are two UEs performing the D2D communication.

For the UE U10

In Step S101, transmitting a wireless signal for indicating at least one of the following:
a first ID;
a second ID; and
a time slot index.

In the step S102, determining an initialization value of a scrambling sequence generator, wherein the initialization value is determined by at least one of the following:
the first ID;
the second ID; and
the time slot index.

In the step S103, generating a D2D scrambling sequence.

In the step S104, performing a scrambling operation on a D2D signal by using the D2D scrambling sequence and transmitting the D2D signal performed by the scrambling operation.

After modulating, the scrambled D2D signal is transmitted to the UE U11 from the UE U10.

For the UE U11

In the step S111, receiving the wireless signal to determine at least one of the following:
the first ID;
the second ID; and
the time slot index.

In the step S112, determining the initialization value of the scrambling sequence generator, wherein the initialization value is determined by at least one of the following:
the first ID;
the second ID; and
the time slot index.

In the step S113, generating the D2D scrambling sequence.

In the step S114, receiving the D2D signal performed by the scrambling operation, and performing a descrambling operation on a demodulated D2D signal by using the D2D scrambling sequence.

In Embodiment I, the first ID is one element in an integer set from 0 to 65535, the second ID is one element in an integer set from 504 to 3080, and the time slot index is one element in an integer set from 0 to 19. The initialization value has a linear relationship with at least one of the following:
the first ID;
the second ID; and
the time slot index.

In one example of Embodiment I, the UE U10 is located outside the network coverage, and the second ID is a constant value X.

### Embodiment II

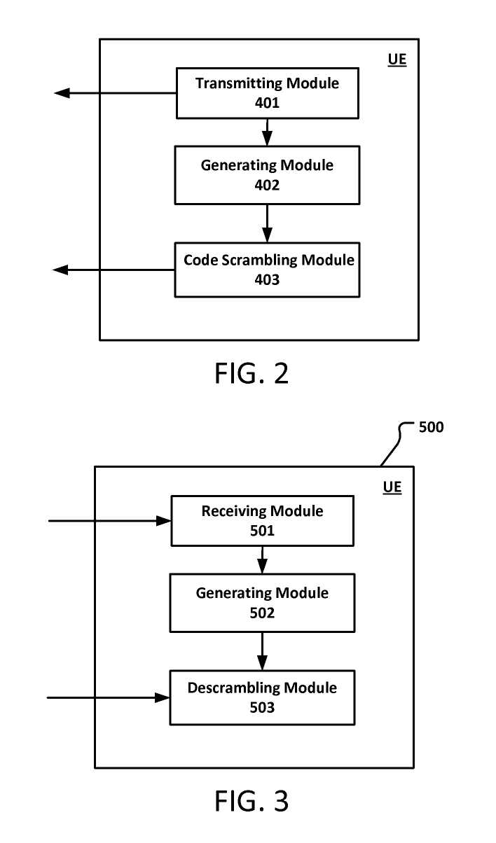

Embodiment II shows a schematic block diagram illustrating the scrambling processing apparatus in the user equipment, as shown in FIG. 2. In the embodiment II, the UE processing apparatus 400 consists of a transmitting module 401, a generating module A402 and a code scrambling module 403.

The transmitting module 401 is used for transmitting a wireless signal for indicating one or more of a first ID, a second ID and a time slot index. The transmitting module 401 is further used for determining an initialization value of a scrambling sequence generator, wherein the initialization value is determined by one or more of the first ID, the second ID and the time slot index. The initialization value has a linear relationship with the first ID, and the initialization value has a linear relationship with the second ID.

The generating module A402 is used for generating a D2D scrambling sequence.

The code scrambling module 403 is used for performing a scrambling operation on a D2D signal by using the D2D scrambling sequence and transmitting the D2D signal performed by the scrambling operation.

In Embodiment II, the first ID is one element in an obtained value set of RNTI, and the time slot index is one element in an obtained value set of nₛ. The second ID is one element in an integer set from 504 to 3080 or −2576 to −1.

### Embodiment III

Embodiment III shows a schematic block diagram illustrating the descrambling processing apparatus in a user equipment, as shown in FIG. 3. In the embodiment III, the UE processing apparatus 500 consists of a receiving module 501, a generating module B502, and a descrambling module 503.

The receiving module 501 is used for receiving a wireless signal to determine one or more of a first ID, a second ID and a time slot index. The receiving module 501 is further used for determining an initialization value of a scrambling sequence generator, wherein the initialization value is determined by one or more of the first ID, the second ID and the time slot index. Wherein, the initialization value has a linear relationship with the first ID, and the initialization value has a linear relationship with the second ID. The generating module B502 is used for generating a D2D scrambling sequence. The descrambling module 503 is used for receiving the D2D signal performed by the scrambling operation and performing a descrambling operation on a demodulated D2D signal by using the D2D scrambling sequence.

In Embodiment III, the first ID is one element in an integer set from 0 to 65535, the second ID is one element in an integer set from 504 to 3080, and the time slot index is one element in an integer set from 0 to 19.

It will be appreciated for those having ordinary skills in the related art that all or part of the above method may be accomplished by a program instructing related hardware. The program may be stored in a computer-readable storage medium, such as read-only memory, a hard disk or CD-ROM. Alternatively, all or part of the steps of the above-described embodiments may be accomplished by one or more integrated circuits. Accordingly, each module in the above-described embodiments may be accomplished by hardware implementation, or may also be realized by the form of software modules. The present disclosure is not limited to any particular form of combination of software and hardware.

Although the present disclosure is illustrated and described with reference to specific embodiments, those skilled in the art will understand that many variations and modifications are readily attainable without departing from the spirit and scope thereof as defined by the appended claims and their legal equivalents.

What is claimed is:

1. A method used in an user equipment (UE), comprising:
A. determining an initialization value of a scrambling sequence generator, wherein the initialization value is determined by at least one of the following:
a first ID;
a second ID; and
a time slot index;
B. generating a D2D scrambling sequence; and
C. performing a scrambling operation on a D2D signal by using the D2D scrambling sequence;
wherein the first ID is one element in an integer set from 0 to 65535, the second ID is one element in an integer set from 504 to 3080, and the time slot index is one element in an integer set from 0 to 19;
wherein the initialization value has a linear relationship with at least one of the following:
the first ID;
the second ID; and
the time slot index.

2. The method used in the user equipment according to claim 1, wherein the UE is located outside a network coverage, and the second ID is a constant X.

3. The method used in the user equipment according to claim 1, wherein the UE is located outside a network coverage, and the first ID is determined by an IEMI of the UE.

4. The method used in the user equipment according to claim 1, wherein a slope of the first ID to the initialization value is 16384, and a slope of the second ID to the initialization value is 1.

5. The method used in the user equipment according to claim 1, wherein the step A further comprises the following steps:
A0. transmitting a wireless signal for indicating at least one of the following:
the first ID;
the second ID; and
the time slot index.

6. The method used in the user equipment according to claim 1, further comprising:
D. transmitting the D2D signal performed by the scrambling operation.

7. A method used in an user equipment (UE), comprising:
A. determining an initialization value of a scrambling sequence generator, wherein the initialization value is determined by at least one of the following:
a first ID;
a second ID; and
a time slot index;
B. generating a D2D scrambling sequence;
C. performing a descrambling operation on a demodulated D2D signal by using the D2D scrambling sequence;
wherein the first ID is one element in an integer set from 0 to 65535, the second ID is one element in an integer set from 504 to 3080, and the time slot index is one element in an integer set from 0 to 19;
wherein the initialization value has a linear relationship with at least one of the following:
the first ID;
the second ID; and
the time slot index.

8. The method used in the user equipment according to claim 7, wherein the UE is located outside a network coverage, and the second ID is a constant X.

9. The method used in the user equipment according to claim 7, wherein the UE is located outside a network coverage, and the first ID is determined by an IEMI of the UE.

10. The method used in the user equipment according to claim 7, wherein the step C comprises the following steps:
receiving the D2D signal performed by the scrambling operation, and performing a descrambling operation on a demodulated D2D signal by using the D2D scrambling sequence.

11. The method used in the user equipment according to claim 7, wherein the step A further comprises the following steps:
A0. transmitting a wireless signal for indicating at least one of the following:
the first ID;
the second ID; and
the time slot index.

12. An user equipment, comprising:
a first module for determining an initialization value of a scrambling sequence generator;
a second module for generating a D2D scrambling sequence; and
a third module for performing a scrambling operation on a D2D signal by using the D2D scrambling sequence;
wherein the first ID is one element in an integer set of 0 to 65535, the second ID is one element in an integer set of 504 to 3080, and the time slot index is one element in an integer set of 0 to 19;
wherein the initialization value is determined by at least one of the following:
a first ID;
a second ID; and
a time slot index;
wherein the initialization value has a linear relationship with at least one of the following:
the first ID;
the second ID; and
the time slot index.

13. The equipment according to claim 12, wherein the first module further transmits a wireless signal for indicating at least one of the following:
the first ID;
the second ID; and
the time slot index.

14. The equipment according to claim 12, wherein
the third module further transmits the D2D signal performed by the scrambling operation.

15. An user equipment, comprising:
a first module for determining an initialization value of a scrambling sequence generator;
a second module for generating a D2D scrambling sequence; and
a third module for performing a descrambling operation on a demodulated D2D signal by using the D2D scrambling sequence;
wherein, the first ID is one element in an integer set from 0 to 65535, the second ID is one element in an integer set from 504 to 3080, and the time slot index is one element in an integer set from 0 to 19;
the initialization value is determined by at least one of the following:
a first ID;
a second ID; and
a time slot index;
the initialization value has a linear relationship with at least one of the following:
the first ID;
the second ID; and
the time slot index.

16. The equipment according to claim 15, wherein the first module further transmits a wireless signal for indicating at least one of the following:
the first ID;
the second ID; and
the time slot index.

17. The equipment according to claim 15, wherein
the third module further transmits the D2D signal performed by the scrambling operation.
